(19) United States
(12) Patent Application Publication
(10) Pub. No.: US 2014/0010336 A1
(43) Pub. Date: Jan. 9, 2014

(54) PHASE CORRECTION CIRCUIT AND PHASE CORRECTION METHOD

(71) Applicant: FUJITSU LIMITED, Kawasaki (JP)

(72) Inventor: Kouichi SUZUKI, Kawasaki (JP)

(73) Assignee: FUJITSU LIMITED, Kawasaki (JP)

(21) Appl. No.: 14/022,563

(22) Filed: Sep. 10, 2013

Related U.S. Application Data
(63) Continuation of application No. PCT/JP2011/057891, filed on Mar. 29, 2011.

(51) Int. Cl. H04L 7/02

(52) U.S. Cl. CPC H04L 7/02
USPC 375/371

(57) ABSTRACT

A variable delay circuit outputs a first delay signal obtained by variably adding a delay value to a first signal having a predetermined phase. A mixer receives the first delay signal and a second signal having a phase different from the predetermined phase, and outputs a synthesized signal of the first delay signal and the second signal. A peak voltage detection unit detects the maximum value of an amplitude voltage of the synthesized signal output from the mixer. A comparator controls the delay value added by the variable delay circuit to match the maximum value detected by the peak voltage detection unit and a predetermined voltage.

### CROSS-REFERENCE TO RELATED APPLICATION

This application is a continuation of International Application No. PCT/JP2011/057891, filed on Mar. 29, 2011, the entire contents of which are incorporated herein by reference.

### FIELD

The embodiments discussed herein are related to a phase correction circuit and a phase correction method.

### BACKGROUND

In recent years, an interface that operates at higher speed has been demanded with growing need for increasing the operation speed of a server. The interface includes a receiving circuit and a transmitting circuit in which the phase of a clock for identifying data is requested to be adjusted. In order to respond to the operation at higher speed, the receiving circuit and the transmitting circuit have been requested to correctly perform phase adjustment. Specifically, for example, the transmitting circuit in a serial communication line that operates at high speed is requested to have accuracy of timing between the clock and the data when parallel data is converted to serial data. The receiving circuit in the serial communication line is requested to have accuracy of timing between the clock and the data when the data is sampled. Accordingly, a clock generation circuit including a phase correction circuit that controls the phase is provided in the receiving circuit and the transmitting circuit.

The phase correction circuit receives an input of signals having different phases from a voltage controlled oscillator (VCO) or a frequency divider that divides a VCO output. Then the phase correction circuit adds a delay, as current quantity, to an identification phase of the data and the clock of the received signal to perform control to obtain a desired phase.

The signals having different phases are, for example, four signals having phases of 0°, 90°, 180°, and 270°. However, even if signals having accurate phase relation are output from a ring oscillator VCO or an LC-VCO, the input signals do not have accurate phase relation due to variation in a wiring structure and a buffer in between the VCO and a mixer. That is, the relation among 0°, 90°, 180°, and 270° of the respective signals is inaccurate. To improve this phase relation, the phase is controlled by the phase correction circuit.

FIG. 13 illustrates an input signal and an output signal in a case where the phase relation is appropriate. FIG. 14 illustrates the input signal and the output signal in a case where there is a skew shift. The skew shift refers to a case where a phase is shifted from a reference state of skew such as a state in which the phase relation of input clock signals is correct.

In FIG. 13, a solid line represents the differential wave form between input signals having phases of 0° and 180°. An alternate long and short dash line represents the differential wave form between input signals having phases of 90° and 270°. A broken line represents an output signal generated from the two differential signals represented by the solid line and the alternate long and short dash line. Each of the graphs represents a state where the phase of the output signal is shifted by π/8, π/4, 3π/8, 3π/4, 5π/4, and 7π/4, in this order from the top to the bottom of the figure. Lines 901 to 906 represent threshold voltages. When the phase relation of the input signals is appropriate, an intersection point between the output signal and the threshold voltage is repeatedly present at regular intervals as represented by dots 911 to 916 regardless of adjustment of the phase of the output signal. In this case, the amount of phase change is constant when the phase of the output signal is changed, so that the data can be correctly identified using such a clock.

In contrast, when a skew shift occurs, as illustrated in FIG. 14, although an intersection point between the output signal and the threshold voltage is at a position on a line 920 if the phase is appropriate, the intersection point between the output signal and the threshold voltage is shifted from the appropriate position by a phase difference 921 or a phase difference 922 because the phase of the output signal is shifted.

Herein, FIG. 15A and FIG. 15B illustrate the phase of the output signal when there is a skew shift. Both in FIG. 15A and FIG. 15B, the vertical axis represents the phase of the output signal and the horizontal axis represents a code for adjusting the phase of the output signal. The amount of phase change is constant when there is no skew shift, and therefore the phase changes linearly with respect to the code as represented by a line 931 in FIG. 15A and a line 933 in FIG. 15B. However, when a phase shift occurs and the phases of the input signals approach, the amount of phase change is inconstant as represented by a broken line 932 in FIG. 15A largely deviating from the line 931. In a case where the phase shift occurs and the phases of the input signals move away from each other, the amount of phase change is inconstant as represented by a broken line 934 in FIG. 15A largely deviating from the line 933. That is, accuracy of the variable amount of the identification phase is deteriorated.

In the related art, disclosed is a technique for correcting the duty of a clock by generating two clock signals of which duties are inverted to each other as a control of phase by a phase correction circuit. Also disclosed is a technique for changing a delay amount while maintaining a phase-locked state. The duty represents, for example, a ratio between a high width and a low width of a clock pulse. Conventional examples are described in Japanese Laid-open Patent Publication No. 2005-135567 and Japanese Patent No. 4310036.

The related art for correcting the duty of a clock can correct, for example, a duty shift in a differential signal having phases of 0° and 180° and a duty shift in a differential signal having phases of 90° and 270°. However, it is difficult for the related art to correct a skew shift between the differential signal having phases of 0° and 180° and the differential signal having phases of 90° and 270°. When a skew shift occurs in each clock, a different amount of phase change per input phase signal is generated for a desired phase of the clock. In other words, a step of the phase of the clock for identifying data may become fine or coarse. A coarse step in a phase change of the clock causes a jitter, and there is a risk that an error rate is deteriorated.

### SUMMARY

According to an aspect of an embodiment, a phase correction circuit includes: a first delay addition unit that receives a first signal having a predetermined phase and outputs a first delay signal obtained by variably adding a delay value to the first signal; a first mixer that receives the first delay signal and a second signal having a phase different from the predetermined phase, and outputs a synthesized signal of the first delay signal and the second signal; a first peak voltage detection unit that detects a maximum value of an amplitude voltage of the synthesized signal output from the first mixer; and a control unit that controls the delay value added by the first delay addition unit to match the maximum value detected by the first peak voltage detection unit and a predetermined voltage.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a phase correction circuit according to a first embodiment;

FIG. 2 illustrates an example of a circuit using an LC-VCO that generates a quadrature phase clock;

FIG. 3 is a circuit diagram of an example of a mixer;

FIG. 4 illustrates a phase change due to a difference in output amplitude peak voltages;

FIG. 5 is a flow chart of correction processing of a skew in the phase correction circuit according to the first embodiment;

FIG. 6 is a block diagram of a transmitter and a receiver having the phase correction circuit according to the embodiment;

FIG. 7 is a block diagram of a multiphase clock generation circuit;

FIG. 8 is a timing chart of a phase adjustment clock, a multiphase clock, and input data;

FIG. 9 is a block diagram of a phase correction circuit according to a second embodiment;

FIG. 10A illustrates a first peak voltage and a second peak voltage in a state where there is no skew shift;

FIG. 10B illustrates the first peak voltage and the second peak voltage in a state where there is a skew shift;

FIG. 11 is a block diagram of a phase correction circuit according to a third embodiment;

FIG. 12 illustrates an example of a variable delay circuit according to the third embodiment;

FIG. 13 illustrates input signals and an output signal in a case where a phase relation is appropriate;

FIG. 14 illustrates the input signals and the output signal in a case where there is a skew shift;

FIG. 15A illustrates the phase of the output signal in a case where there is a skew shift; and

FIG. 15B illustrates the phase of the output signal in a case where there is a skew shift.

### DESCRIPTION OF EMBODIMENT(S)

Preferred embodiments of the present invention will be explained with reference to accompanying drawings. The phase correction circuit and the phase correction method disclosed herein are not limited by the embodiments below.

### [a] First Embodiment

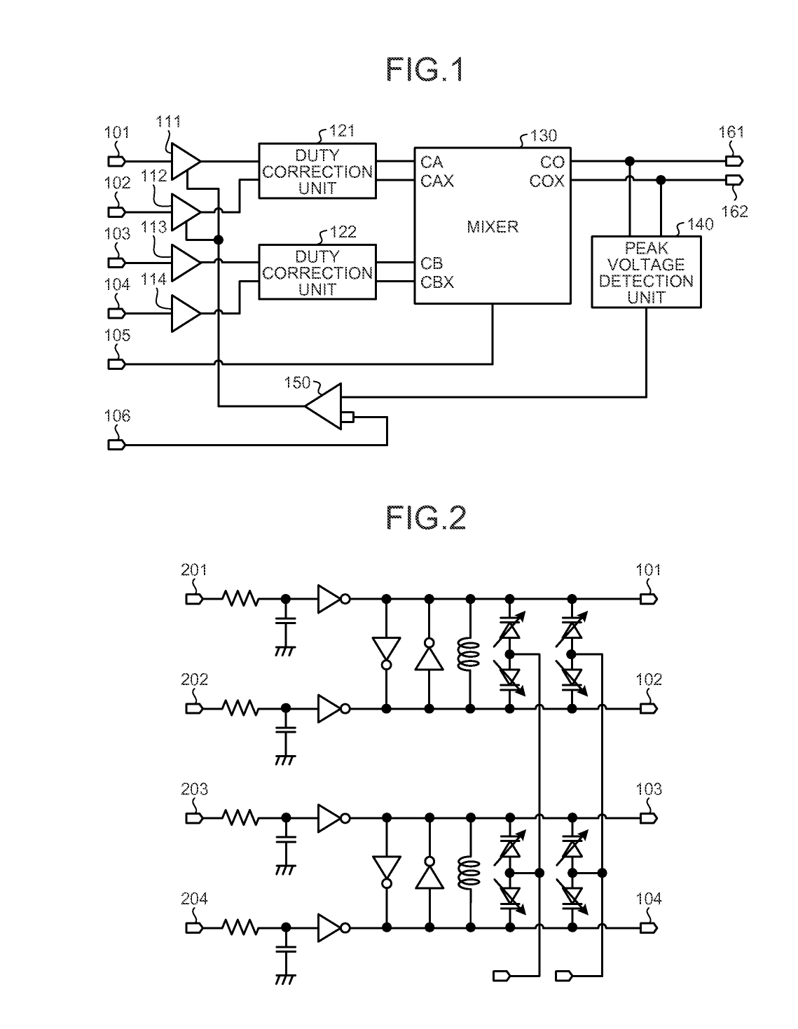

FIG. 1 is a block diagram of a phase correction circuit according to a first embodiment. As illustrated in FIG. 1, the phase correction circuit according to the first embodiment includes input terminals 101 to 106, variable delay circuits 111 and 112, fixed delay circuits 113 and 114, duty correction units 121 and 122, a mixer 130, a peak voltage detection unit 140, a comparator 150, and output terminals 161 and 162.

A sinusoidal signal CA is supplied to the input terminal 101. A sinusoidal signal CAX is supplied to the input terminal 102. The signal CA is a clock signal having a phase of 0° as a reference phase. The signal CAX is an inverted signal (complementary signal) of the signal CA and a clock signal having a phase of 180°. The signal CA and the signal CAX are examples of a “first signal”.

A sinusoidal signal CB is supplied to the input terminal 103. A sinusoidal signal CBX is supplied to the input terminal 104. The signal CB is a clock signal having a phase of 90°. The signal CBX is an inverted signal of the signal CB, and a clock signal having a phase of 270°. The signal CB and the signal CBX are an example of a “second signal”.

The phases of the clock signals input to the terminals are assumed to be 0°, 90°, 180°, and 270°. However, a duty shift and a skew shift are occurring. The skew shift refers to a case where a phase is shifted from a reference state of skew such as a state in which the phase relation of the input clock signals is correct.

FIG. 2 illustrates an example of a circuit using an LC-VCO that generates a quadrature phase clock. A signal having a phase of 90° is supplied to a terminal 201. A signal having a phase of 270° is supplied to a terminal 202. A signal having a phase of 180° is supplied to a terminal 203. A signal having a phase of 0° is supplied to a terminal 204. The signals are subjected to frequency control and the like through a circuit in FIG. 2 and supplied to the input terminals 101 to 104.

The variable delay circuit 111 receives an input of the signal CA supplied to the input terminal 101. The variable delay circuit 111 receives a control signal from the comparator 150 to be described later and increases or decreases a delay. Then the variable delay circuit 111 gives the controlled delay to the signal CA and shifts its phase. For example, when receiving a control signal that gives a delay of +ΔT from the comparator 150, the variable delay circuit 111 gives a delay obtained by adding ΔT to the current delay amount to the signal CA. For example, when receiving a control signal that gives a delay of −ΔT from the comparator 150, the variable delay circuit 111 gives a delay obtained by subtracting ΔT from the current delay amount to the signal CA. Then the variable delay circuit 111 outputs the signal CA to which the delay is given to the duty correction unit 121.

The variable delay circuit 112 receives an input of the signal CAX supplied to the input terminal 102. The variable delay circuit 112 receives a control signal from the comparator 150 to be described later and increases or decreases a delay. The control signal received by the variable delay circuit 112 from the comparator 150 is the same as an instruction received by the variable delay circuit 111 from the comparator 150. Then the variable delay circuit 112 gives the controlled delay to the signal CAX and shifts its phase. For example, when receiving a control signal that gives a delay of +ΔT from the comparator 150, the variable delay circuit 112 gives a delay obtained by adding ΔT to the current delay amount to the signal CAX. For example, when receiving a control signal that gives a delay of −ΔT from the comparator 150, the variable delay circuit 112 gives a delay obtained by subtracting ΔT from the current delay amount to the signal CAX. Then the variable delay circuit 112 outputs the signal CAX to which the delay is given to the duty correction unit 121. The variable delay circuit 111 and the variable delay circuit 112 are examples of a “first delay addition unit”.

The fixed delay circuit 113 receives an input of the signal CB supplied to the input terminal 103. The fixed delay circuit 113 gives a predetermined delay to the signal CB and shifts its phase. Then the fixed delay circuit 113 outputs the signal CB to which the delay is given to the duty correction unit 122.

The fixed delay circuit 114 receives an input of the signal CBX supplied to the input terminal 104. The fixed delay circuit 114 gives a predetermined delay to the signal CBX and shifts its phase. Then the fixed delay circuit 114 outputs the signal CB to which the delay is given to the duty correction unit 122.

The duty correction unit 121 receives an input of the signal CA from the variable delay circuit 111. The duty correction unit 121 receives an input of the signal CAX from the variable delay circuit 112. Then the duty correction unit 121 performs correction so as to eliminate a duty shift between the signal CA and the signal CAX. The duty correction unit 121 outputs the signal CA and the signal CAX on which the correction is performed so as to compensate the duty to the mixer 130. The duty may be corrected by, for example, a method of connecting inverters by cross coupling in between differential clocks (between CA and CAX, and between CB and CBX).

The duty correction unit 122 receives an input of the signal CB from the fixed delay circuit 113. The duty correction unit 122 receives an input of the signal CBX from the fixed delay circuit 114. Then the duty correction unit 122 performs correction so as to eliminate a duty shift between the signal CB and the signal CBX. The duty correction unit 122 outputs the signal CB and the signal CBX on which the correction is performed so as to compensate the duty to the mixer 130.

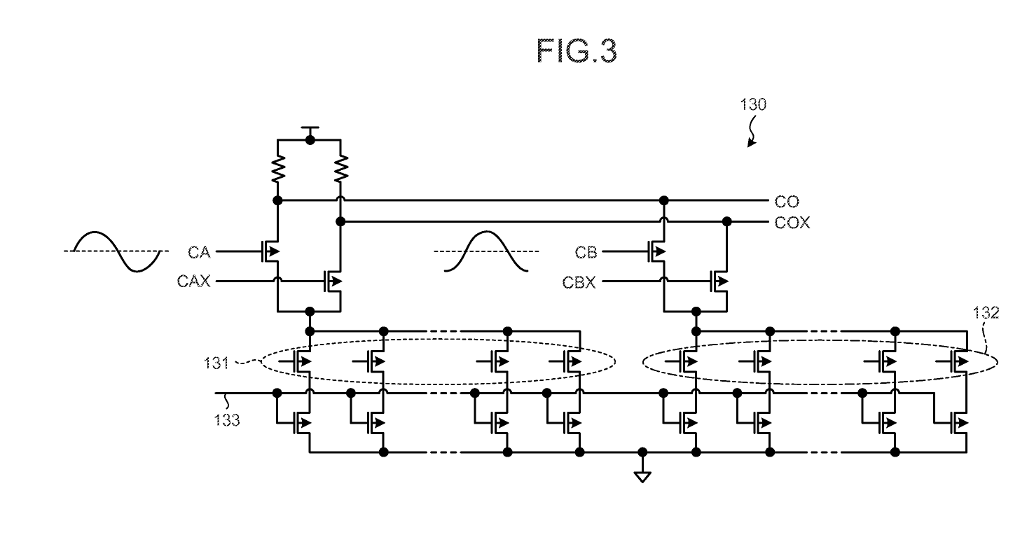

FIG. 3 is a circuit diagram of an example of the mixer. As illustrated in FIG. 3, the mixer 130 according to the first embodiment includes a plurality of switches for weighting signals when synthesizing the signals. A weight is a value indicating what percentage of the signal is used to generate a synthesized signal. A switch group 131 includes switches for weighting the signal CA and the signal CAX, and a switch group 132 includes switches for weighting the signal CB and the signal CBX. A constant current source 133 supplies a constant current via each of the switches. The switch group 131 and the switch group 132 are controlled by a digital code received by the mixer 130. That is, the digital code determines turning on and off of each switch included in the switch group 131 and the switch group 132. A smaller number of the switches turned on lead to a lower current to be supplied and a more advanced phase of the signal. A larger number of the switches turned on lead to a higher current to be supplied and a more delayed phase of the signal.

The mixer 130 receives inputs of the signal CA and the signal CAX from the duty correction unit 121. The mixer 130 also receives inputs of the signal CB and the signal CBX from the duty correction unit 122. The mixer 130 receives an input of a digital code that is a control signal for performing phase interpolation. For example, the digital code is input from a digital filter and the like provided in a receiver as described later.

The mixer 130 weights the signal CA having a phase of 0° and the signal CB having a phase of 90° using the digital code. Then the mixer 130 adds the weighted signal CA to the weighted signal CB to generate an output signal CO. The mixer 130 weights the signal CAX having a phase of 180° and the signal CBX having a phase of 270° using the digital code. Then the mixer 130 adds the weighted signal CAX to the weighted signal CBX to generate an output signal COX. The output signal COX is an inverted signal of the output signal CO. As described above, the mixer 130 shifts the phases of the output signal CO and the output signal COX by weighting. The mixer 130 performs phase interpolation by shifting the phases of the output signal CO and the output signal COX. In the first embodiment, the mixer 130 has a variable range of phase 90°.

In a case of initial training to correct a skew shift, used is a digital code for performing control to match current from a current source that weights the signal CA and the signal CAX and current from a current source that weights the signal CB and the signal CBX. That is, the mixer 130 matches the number of switches turned on in the switch group 131 and that in the switch group 132. In the first embodiment, matching is made between current to a differential pair of the signal CA and the signal CAX and current to a differential pair of the signal CB and the signal CBX for convenience of explanation. However, the present invention is not limited thereto. That is, as long as a wave form can be specified in a state where there is no skew shift when an appropriate current is applied to each of the differential pairs, the current to be applied may be any value.

The mixer 130 outputs the output signal CO from the output terminal 161. The mixer 130 outputs the output signal COX from the output terminal 162. The mixer 130 outputs the output signal CO and the output signal COX to the peak voltage detection unit 140 as well. The mixer 130 is an example of a “first mixer”.

The peak voltage detection unit 140 receives inputs of the output signal CO and the output signal COX from the mixer 130. The peak voltage detection unit 140 detects a peak value of an output amplitude voltage (hereinafter, referred to as an “output amplitude peak voltage”) that is the maximum value of an amplitude voltage of the output signal CO and the output signal COX. Then the peak voltage detection unit 140 outputs the detected output amplitude peak voltage (hereinafter, referred to as a “detected voltage”) to the comparator 150. The peak voltage detection unit 140 is an example of a “first peak voltage detection unit”.

The comparator 150 receives an input of the output amplitude peak voltage in a case where there is no skew shift (hereinafter, referred to as a “reference voltage”). The comparator 150 also receives an input of the detected voltage. The comparator 150 compares the detected voltage with the reference voltage and calculates a difference therebetween. Then the comparator 150 converts the calculated potential difference to a digital signal, and outputs the digital signal to the variable delay circuit 111 and the variable delay circuit 112.

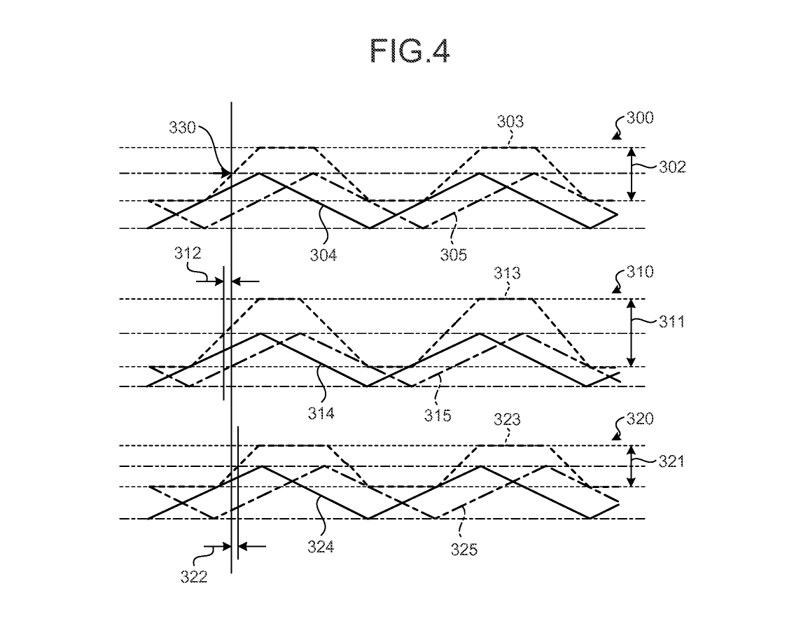

With reference to FIG. 4, a phase change due to a difference in the output amplitude peak voltage will be described. FIG. 4 illustrates the phase change due to a difference in the output amplitude peak voltage. In graphs 300, 310, and 320 of FIG. 4, a vertical axis represents the amplitude voltage and a horizontal axis represents the phase. The graph 300, which is the uppermost graph on FIG. 4, represents amplitude power in a state where there is no skew shift. A broken line 303 represents the differential wave form between the output signal CO and the output signal COX in a state where there is no skew shift. In a case where the threshold voltage and the broken line 303 intersect at a dot 330 and there is no skew shift, the amplitude voltage of the output signal CO and the output signal COX has the threshold voltage at a position of a phase 301. A solid line 304 represents the differential wave form between the signal CA and the signal CAX, that is the basis of the differential wave form represented by the broken line 303. An alternate long and short dash line 305 represents the differential wave form between the signal CB and the signal CBX, that is the basis of the differential wave form represented by the broken line 303. The broken line 303 is a wave form obtained by synthesizing the solid line 304 and the alternate long and short dash line 305. Then the output amplitude peak voltage of the broken line 303 becomes the reference voltage. The reference voltage is represented by a potential difference 302.

In contrast, the graph 310, which is a middle graph on FIG. 4, represents the amplitude power in a state where there is such a skew shift that the phase difference is reduced. A broken line 313 represents the differential wave form between the output signal CO and the output signal COX in a state where there is such a skew shift that the phase difference is reduced. A solid line 314 represents the differential wave form between the signal CA and the signal CAX, that is the basis of the differential wave form represented by the broken line 313. An alternate long and short dash line 315 represents the differential wave form between the signal CB and the signal CBX, that is the basis of the differential wave form represented by the broken line 313. The phase difference between the solid line 314 and the alternate long and short dash line 315 is smaller than that between the solid line 304 and the alternate long and short dash line 305 in the graph 300. A potential difference 311 represents an output peak voltage of the broken line 313. In this case, the potential difference 311 is larger than the potential difference 302. That is, the output amplitude peak voltage is higher than the reference voltage. In this case, as represented by a phase difference 312, the position of the phase corresponding to the threshold voltage of the broken line 313 is behind the phase 301. Therefore, in order to cause the phase corresponding to the threshold voltage to coincide with the reference broken line 303, the phase of the broken line 313, which is a synthesized wave form, is advanced. Accordingly, when the output amplitude peak voltage is higher than the reference voltage, the phase corresponding to the threshold voltage approaches the reference broken line 303 by increasing the delay of the signal CA and the signal CAX.

The graph 320, which is the lowermost graph on FIG. 4, represents the amplitude power in a state where there is such a skew shift that the phase difference increases. A broken line 323 represents the differential wave form between the output signal CO and the output signal COX in a state where there is such a skew shift that the phase difference is increased. A solid line 324 represents the differential wave form between the signal CA and the signal CAX, that is the basis of the differential wave form represented by a broken line 323. An alternate long and short dash line 325 represents the differential wave form between the signal CB and the signal CBX, that is the basis of the differential wave form represented by the broken line 323. The phase difference between the solid line 324 and the alternate long and short dash line 325 is larger than that between the solid line 304 and the alternate long and short dash line 305 in the graph 300. A potential difference 321 represents an output peak voltage of the broken line 323. In this case, the potential difference 321 is smaller than the potential difference 302. That is, the output amplitude peak voltage is lower than the reference voltage. In this case, as represented by a phase difference 322, the position of the phase corresponding to the threshold voltage of the broken line 323 is ahead of the phase 301. Therefore, in order to cause the phase corresponding to the threshold voltage to coincide with the reference broken line 303, the phase of the broken line 323, which is a synthesized wave form, is delayed. Accordingly, when the output amplitude peak voltage is lower than the reference voltage, the phase corresponding to the threshold voltage approaches the reference broken line 303 by decreasing the delay of the signal CA and the signal CAX.

That is, when the detected voltage is higher than the reference voltage, the comparator 150 outputs a control signal for increasing the delay of the signal CA and the signal CAX to the variable delay circuit 111 and the variable delay circuit 112, respectively. When the detected voltage is lower than the reference voltage, the comparator 150 outputs a control signal for decreasing the delay of the signal CA and the signal CAX to the variable delay circuit 111 and the variable delay circuit 112, respectively. In the first embodiment, the variable delay circuit 111 and the variable delay circuit 112 are analogously controlled, so that the comparator 150 performs control to match the detected voltage and the reference voltage by shifting one by one a control code that gives the delay, for example.

The first embodiment describes a case where the variable delay circuit is analogously controlled, however, the variable delay circuit may be digitally controlled. In such a case, for example, the comparator 150 may store therein a voltage difference and a code for adjusting the voltage difference in an associated manner, and transmit a code corresponding to a difference between the detected voltage and the reference voltage to the variable delay circuit.

The following describes a relation between the output amplitude peak voltage and the delay amount. Ir denotes a current in the case of matching current for weighting the differential pair of the signal CA and the signal CAX and current for weighting a differential pair of the signal CB and the signal CBX. The current of the differential pair of the signal CA and the signal CAX is denoted as Ia, and the current of the differential pair of the signal CB and the signal CBX is denoted as Ib. In a case where there is no skew shift, Ia=Ir×sin(x+π/2) is established. In a case where there is no skew shift, Ib=Ir×sin(x) is also established. Then, when the current of the differential pair of the output signal CO and the output signal COX as synthesized signals is denoted as Io, Io=Ia+Ib is established. That is, Io=2^{1/2}×Ir×sin(x+φ) is established. Accordingly, the voltage of the differential pair of the output signal CO and the output signal COX is Io×R. Therefore, when the reference voltage, which is the output amplitude peak voltage in a case where there is no skew shift, is denoted as Vref, Vref=2^{1/2}×Ir×R is established. In this case, when a time for the signal CA to have a certain voltage is denoted as T(Ia) and time for the signal CB to have the same voltage is denoted as T(Ib), the skew is represented by T(Ia)−T(Ib)=π/2. That is, in a state where there is no skew shift, the skew is π/2.

When the detected voltage is denoted as Vo and Vo>Vref is established, a phase difference between the differential pair of the signal CA and the signal CAX and the differential pair of the signal CB and the signal CBX is small. In this case, Ia=Ir×sin(x+π/2), and Ib=Ir×sin(x+φ) are established, where φ represents a phase by which the phase of the differential pair of the signal CA and the signal CAX and the phase of the differential pair of the signal CB and the signal CBX approach each other. In this case, the skew is represented by T(Ia)−T(Ib)=π/2−φ. That is, the skew shift is −φ as compared with the state where there is no skew shift. Then the comparator 150 outputs a control signal for increasing the delay so that the phase of the output signal CO and the output signal COX is increased by φ to the variable delay circuit 111 and the variable delay circuit 112.

When Vo<Vref is established, the phase difference between the differential pair of the signal CA and the signal CAX and the differential pair of the signal CB and the signal CBX is large. In this case, Ia=Ir×sin(x+π/2) and Ib=Ir×sin(x−φ) are established, where φ represents a phase by which the phase of the differential pair of the signal CA and the signal CAX and the phase of the differential pair of the signal CB and the signal CBX move away from each other. In this case, the skew is represented by T(Ia)−T(Ib)=π/2+φ. That is, the skew shift is +φ as compared with the state where there is no skew shift. Then the comparator 150 outputs a control signal for decreasing the delay so that the phase of the output signal CO and the output signal COX is decreased by φ to the variable delay circuit 111 and the variable delay circuit 112. The comparator 150 is an example of a “control unit”.

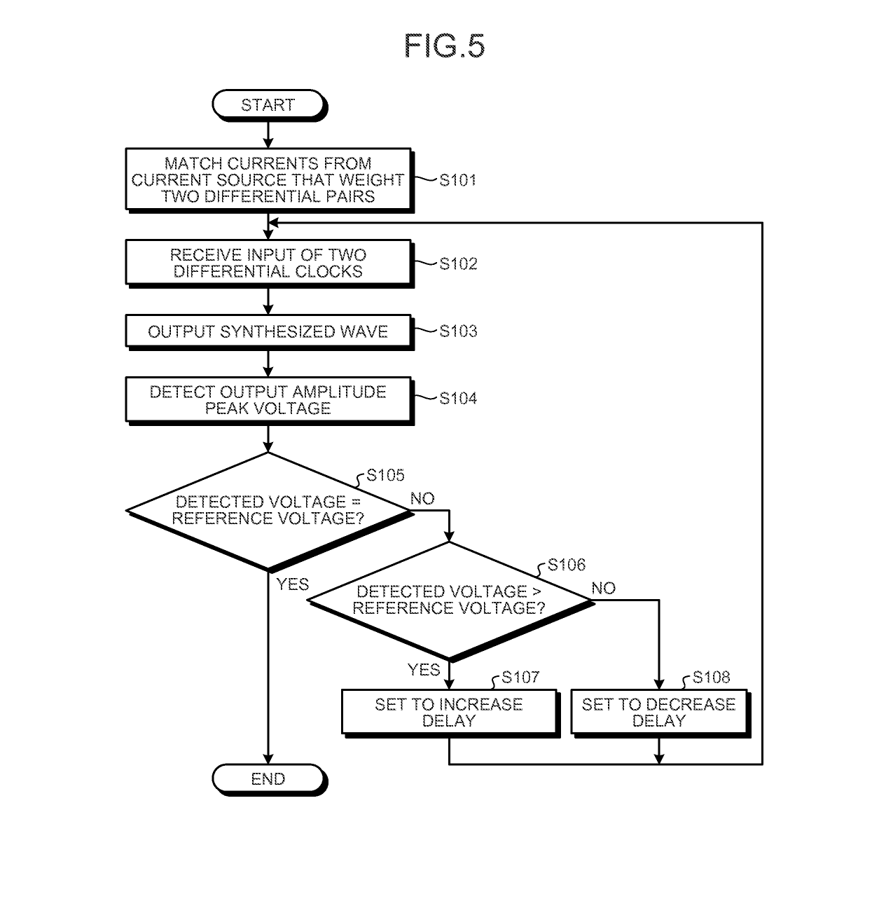

The following describes correction processing of a skew in the phase correction circuit according to the first embodiment with reference to FIG. 5. FIG. 5 is a flow chart of the correction processing of a skew in the phase correction circuit according to the first embodiment.

The mixer 130 receives a predetermined digital code and matches currents from the current source that weight the differential pair of the signal CA and the signal CAX and the differential pair of the signal CB and the signal CBX (Step S101).

Next, the mixer 130 receives an input of the signal CA and the signal CAX, and the signal CB and the signal CBX, which constitute two differential clocks (Step S102).

Subsequently, the mixer 130 outputs the output signal CO, which is the synthesized signal of the signal CA and the signal CB, and the output signal COX, which is the synthesized signal of the signal CAX and the signal CBX (Step S103).

The peak voltage detection unit 140 acquires the output signal CO and the output signal COX from the mixer 130. Then the peak voltage detection unit 140 detects the output amplitude peak voltage, which is the maximum value of the amplitude voltage of the output signal CO and the output signal COX (Step S104).

The comparator 150 acquires the detected voltage from the peak voltage detection unit 140. Then the comparator 150 compares the detected voltage with the reference voltage and determines whether the detected voltage matches the reference voltage (detected voltage=reference voltage) (Step S105). When the detected voltage matches the reference voltage (Yes at Step S105), the comparator 150 ends the correction processing of a skew.

In contrast, when the detected voltage is different from the reference voltage (No at Step S105), the comparator 150 determines whether the detected voltage is higher than the reference voltage (detected voltage>reference voltage) (Step S106). Then when the detected voltage is higher than the reference voltage (Yes at Step S106), the comparator 150 outputs a control signal for increasing the delay amount to the variable delay circuit 111 and the variable delay circuit 112 (Step S107), and the process returns to Step S102.

In contrast, when the detected voltage is lower than the reference voltage (No at Step S106), the comparator 150 outputs the control signal for decreasing the delay amount to the variable delay circuit 111 and the variable delay circuit 112 (Step S108), and the process returns to Step S102.

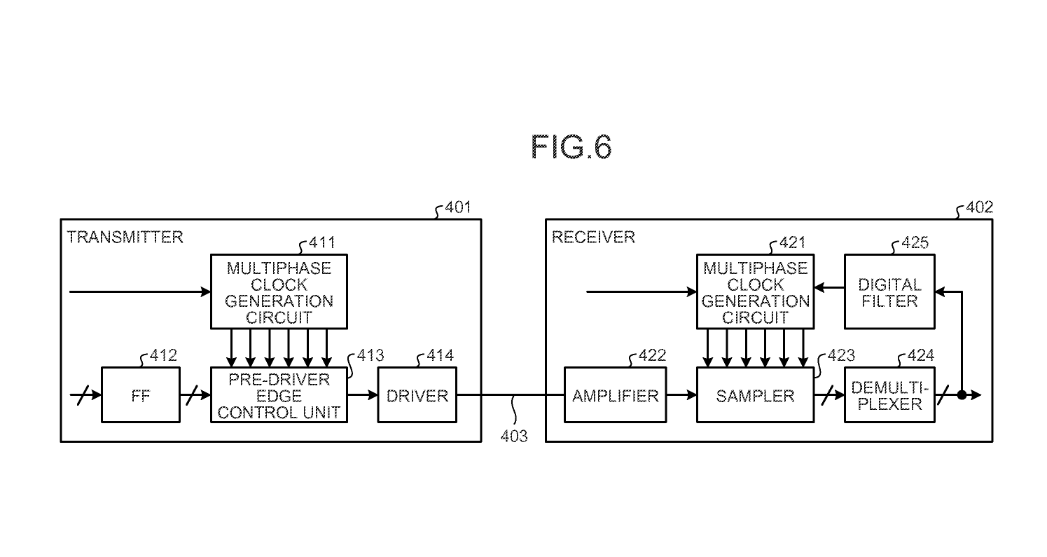

FIG. 6 is a block diagram of a transmitter and a receiver having the phase correction circuit according to the first embodiment. This transmitter 401 includes a multiphase clock generation circuit 411, a flip flop (FF) 412, a pre-driver edge control unit 413, and a driver 414. This receiver 402 includes a multiphase clock generation circuit 421, an amplifier 422, a sampler 423, a demultiplexer 424, and a digital filter 425.

The multiphase clock generation circuit 411 receives an input of the reference clock. The multiphase clock generation circuit 411 generates a plurality of clocks having different phases. Then the multiphase clock generation circuit 411 outputs the generated clocks to the pre-driver edge control unit 413.

The FF 412 receives data input. Then after giving a delay of a certain period to the data, the FF 412 outputs the data to the pre-driver edge control unit 413.

The pre-driver edge control unit 413 receives an input of the clocks having different phases from the multiphase clock generation circuit 411. The pre-driver edge control unit 413 receives data input from the FF 412. The pre-driver edge control unit 413 adjusts the timing of an edge of the data in synchronization with the input clock. Then the pre-driver edge control unit 413 outputs the data of which timing of the edge is adjusted, to the driver 414.

The driver 414 transmits the data received from the pre-driver edge control unit 413 to the receiver 402 via a communication line 403. The communication line 403 is, for example, a communication line that transmits a serial signal by a differential signal.

The multiphase clock generation circuit 421 receives an input of the reference clock. When the reference clock in the transmitter 401 is denoted as TxClk and the reference clock in the receiver 402 is denoted as RxClk, the multiphase clock generation circuit 421 receives an input of RxClk. For example, RxClk is a clock having the same frequency as that of TxClk, and is obtained by multiplying a reference clock such as a quartz oscillator on the receiver 402 side through a phase locked loop (PLL). Each of the frequencies of TxClk and RxClk may be any frequency by which RxClk can obtain a phase difference signal. If the frequency is high, for example, it may be divided. Therefore, the frequencies of TxClk and RxClk may be different from each other.

The multiphase clock generation circuit 421 receives an input of a digital code from the digital filter 425. The multiphase clock generation circuit 421 uses current controlled by the received digital code to adjust the phase of each signal of the reference clock. The multiphase clock generation circuit 421 generates a multiphase clock that is a plurality of clocks having different phases. Then the multiphase clock generation circuit 421 outputs the generated multiphase clock to the sampler 423.

The amplifier 422 receives the data transmitted from the transmitter 401. The amplifier 422 amplifies the received data. Then the amplifier 422 outputs the amplified data to the sampler 423.

The sampler 423 receives the data input from the amplifier 422. The sampler 423 receives an input of a plurality of clocks having different phases from the multiphase clock generation circuit 421. The sampler 423 samples the received data in synchronization with the received clocks. Then the sampler 423 outputs the data sampled in different phases to the demultiplexer 424.

The demultiplexer 424 demultiplexes the data sampled in different phases that is received from the sampler 423.

The digital filter 425 processes the sampled data, and generates a digital code corresponding to a timing relation between the clock generated by the multiphase clock generation circuit 421 and the received data. Then the digital filter 425 outputs the generated digital code to the multiphase clock generation circuit 421.

The phase correction circuit according to the first embodiment is mounted to the multiphase clock generation circuit 411 and the multiphase clock generation circuit 421. The multiphase clock generation circuit 421 will be described in detail.

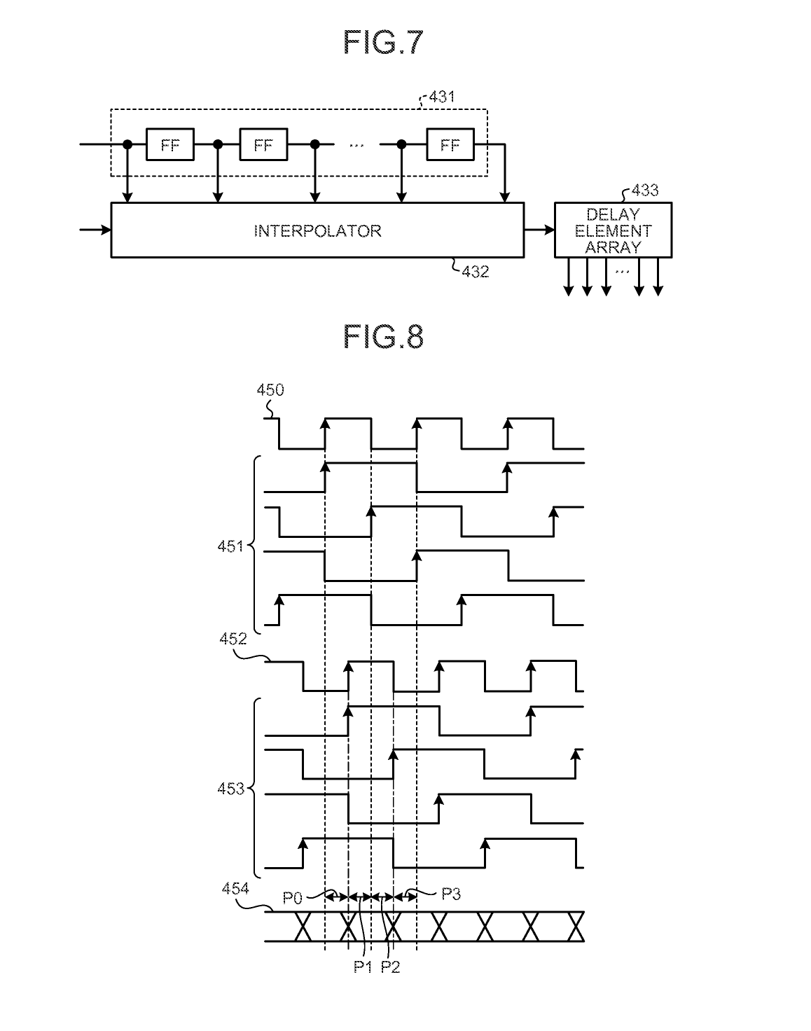

FIG. 7 is a block diagram of the multiphase clock generation circuit. The multiphase clock generation circuit 421 includes a multiphase clock generation unit 431, an interpolator 432, and a delay element array 433.

In the multiphase clock generation unit 431, the FFs corresponding to the number of output phases are arranged in series. The multiphase clock generation unit 431 receives an input of the reference clock. For example, the multiphase clock generation unit 431 in the multiphase clock generation circuit 411 receives an input of TxClk described above. The multiphase clock generation unit 431 in the multiphase clock generation circuit 421 receives an input of RxClk described above. The multiphase clock generation unit 431 causes the sequentially input clocks to pass through the FFs to sequentially give a predetermined delay to each of the clocks. The multiphase clock generation unit 431 outputs each of the clocks that are given the delay by each of the FFs to the interpolator. In the first embodiment, the multiphase clock generation unit 431 outputs the clocks having four phases of 0°, 90°, 180°, and 270°.

The interpolator 432 receives an input of a digital code from the digital filter 425 (refer to FIG. 6). The interpolator 432 receives an input of a plurality of clocks having different phases from the multiphase clock generation unit 431. The interpolator 432 differently weights and adds the received clocks to each other to generate a clock adjusted to have a phase instructed by the received digital code (hereinafter, referred to as a “phase adjustment clock”). The interpolator 432 outputs the generated phase adjustment clock to the delay element array 433. The phase correction circuit according to the first embodiment is mounted on the interpolator 432.

The delay element array 433 receives an input of the phase adjustment clock from the interpolator 432. The delay element array 433 generates a multiphase clock in synchronization with the received phase adjustment clock. Then the delay element array 433 outputs the generated multiphase clock to the sampler 423.

FIG. 8 is a timing chart of the phase adjustment clock, the multiphase clock, and the input data. In FIG. 8, the horizontal axis represents time. FIG. 8 illustrates an example of generating clocks having four phases from two sets of phase adjustment clocks.

The interpolator 432 outputs a clock 450 and a clock 452 to the delay element array 433. The phase of the clock 450 is shifted from the phase of the clock 452 by 90°. The clock 450 and the clock 452 are examples of the phase adjustment clock.

The delay element array 433 divides the clock 450 and shifts the phases thereof to generate a clock group 451 including the clocks having four different phases. Then the delay element array 433 divides the clock 452 and shifts the phases thereof to generate a clock group 453 including the clocks having four different phases. Each clock in the clock group 451 and each clock in the clock group 453 have the same shift amount as that between the phases of the clock 450 and the clock 452. The clocks included in the clock group 451 and the clock group 453 are examples of the multiphase clock. Then the delay element array 433 outputs the clock group 451 and the clock group 453.

The sampler 423 in FIG. 6 receives inputs of the clock group 451 and the clock group 453. The sampler 423 uses each clock included in the clock group 451 as a clock for recognizing data. That is, the sampler 423 recognizes data when each clock included in the clock group 451 rises. The sampler 423 uses each clock included in the clock group 453 as a clock for recognizing an edge. That is, the sampler 423 recognizes an edge of the data when each clock included in the clock group 453 rises. Accordingly, as represented by intervals P0 to P3 of data 454 in FIG. 8, the timing for recognizing the data and the timing for recognizing the edge are generated at regular intervals. Accordingly, the sampler 423 correctly recognizes the data 454.

As described above, the phase correction circuit according to the first embodiment detects the output amplitude peak voltage of differential pairs output from the mixer, and adjusts the delay of one of the differential pairs by using a difference between the detected output amplitude peak voltage and the output amplitude peak voltage in a state where there is no skew shift. This corrects a skew shift between the input differential pairs and improves the accuracy of intervals between the phases of an input phase signal and the accuracy of the variable amount of an identification phase.

In the first embodiment, the delay of the signal CA and the signal CAX is changed to adjust the skew. Alternatively, the delay of the signal CB and the signal CBX may be changed to adjust the skew.

In the first embodiment, the phase of a signal input to each terminal is 0°, 90°, 180°, or 270°. However, other values may be employed. In the first embodiment, the input clock has four phases. However, the number of the phases of the input clock is not limited thereto, and may be any other value.

### [b] Second Embodiment

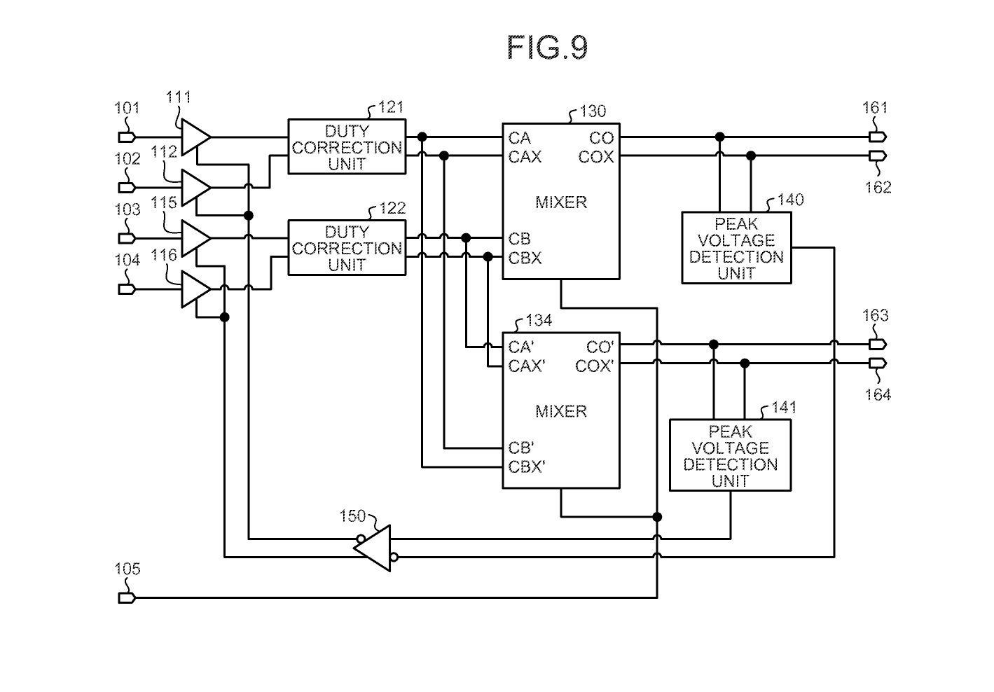

FIG. 9 is a block diagram of the phase correction circuit according to a second embodiment. The phase correction circuit according to the second embodiment is different from that of the first embodiment in the following points: another mixer is added to the phase correction circuit, and the phase correction circuit compares the output amplitude peak voltages of the signals output from the mixers with each other to adjust the delay by a difference between the voltages. The following mainly describes the generation of the signal by the added mixer and a control of the delay amount by comparing the output amplitude peak voltages. In FIG. 9, each component having the same reference numeral as that in FIG. 1 has the same function as that in FIG. 1 unless specifically described.

As illustrated in FIG. 9, the phase correction circuit according to the second embodiment includes a mixer 134 and a peak voltage detection unit 141 in addition to the correction circuit in the first embodiment. The phase correction circuit according to the second embodiment includes a variable delay circuit 115 and a variable delay circuit 116 instead of the fixed delay circuit 113 and the fixed delay circuit 114 in the first embodiment.

Similarly to the first embodiment, the variable delay circuit 111 gives a delay to the signal CA according to a control signal received from the comparator 150, and outputs the signal CA to the duty correction unit 121. Similarly to the first embodiment, the variable delay circuit 112 gives a delay to the signal CAX according to a control signal received from the comparator 150, and outputs the signal CAX to the duty correction unit 121.

The variable delay circuit 115 receives an input of the signal CB supplied to the input terminal 104. The variable delay circuit 115 receives a control signal from the comparator 150 to be described later and increases or decreases a delay. Then the variable delay circuit 115 gives the controlled delay to the signal CB and shifts its phase. For example, when receiving a control signal that gives a delay of +ΔT from the comparator 150, the variable delay circuit 115 gives a delay obtained by adding ΔT to the current delay amount to the signal CB. For example, when receiving a control signal that gives a delay of −ΔT from the comparator 150, the variable delay circuit 115 gives a delay obtained by subtracting ΔT from the current delay amount to the signal CB. Then the variable delay circuit 115 outputs the signal CB to which the delay is given to the duty correction unit 122.

The variable delay circuit 116 receives an input of the signal CBX supplied to the input terminal 103. The variable delay circuit 116 receives the control signal from the comparator 150 to be described later and increases or decreases a delay. The control signal received by the variable delay circuit 116 from the comparator 150 is the same as an instruction received by the variable delay circuit 115 from the comparator 150. Then the variable delay circuit 116 gives the controlled delay to the signal CBX and shifts its phase. For example, when receiving a control signal that gives a delay of +ΔT from the comparator 150, the variable delay circuit 116 gives a delay obtained by adding ΔT to the current delay amount to the signal CBX. For example, when receiving a control signal that gives a delay of −ΔT from the comparator 150, the variable delay circuit 116 gives a delay obtained by subtracting ΔT from the current delay amount to the signal CBX. Then the variable delay circuit 116 outputs the signal CBX to which the delay is given to the duty correction unit 122. The variable delay circuit 115 and the variable delay circuit 116 are examples of a “second delay addition unit”.

The duty correction unit 121 receives an input of the signal CA from the variable delay circuit 111. The duty correction unit 121 receives an input of the signal CAX from the variable delay circuit 112. Then the duty correction unit 121 performs correction so as to eliminate a duty shift between the signal CA and the signal CAX. The duty correction unit 121 outputs the signal CA and the signal CAX on which the correction is performed so as to compensate the duty to the mixer 130. The duty correction unit 121 outputs the signal CA to the mixer 134 as a signal CBX′ in the mixer 134. The duty correction unit 121 outputs the signal CAX to the mixer 134 as a signal CB′ in the mixer 134.

The duty correction unit 122 receives an input of the signal CB from the variable delay circuit 115. The duty correction unit 122 receives an input of the signal CBX from the variable delay circuit 116. Then the duty correction unit 122 performs correction so as to eliminate the duty shift between the signal CB and the signal CBX. The duty correction unit 122 outputs the signal CB and the signal CBX on which the correction is performed so as to compensate the duty to the mixer 130. The duty correction unit 122 outputs the signal CB to the mixer 134 as the signal CA′ in the mixer 134. The duty correction unit 122 outputs the signal CBX to the mixer 134 as the signal CAX′ in the mixer 134.

The mixer 134 receives an input of a signal having a phase of 90° as the signal CA′ and a signal having a phase of 270° as the signal CAX′ from the duty correction unit 122. The mixer 134 receives an input of a signal having a phase of 180° as the signal CB′ and a signal having a phase of 0° as the signal CBX′ from the duty correction unit 121. The mixer 134 receives an input of a digital code that is a control signal for performing phase interpolation. This digital code is the same as the digital code that is input to the mixer 130.

The mixer 134 weights the signal CA′ having a phase of 90° and the signal CB′ having a phase of 180° using the digital code. Then the mixer 134 adds the weighted signal CA′ to the weighted signal CB′ to generate an output signal CO′. The mixer 134 weights the signal CAX′ having a phase of 270° and the signal CBX′ having a phase of 0° using the digital code. Then the mixer 134 adds the weighted signal CAX′ to the weighted signal CBX′ to generate an output signal COX′. The output signal COX′ is an inverted signal of the output signal CO′. That is, in the mixer 134, the weight given to the differential pair of the signal CA and the signal CAX by the mixer 130 is given to the signal CB′ and the signal CBX′. In the mixer 134, a signal obtained by inverting the differential pair of the signal CA and the signal CAX in the mixer 130 is the signal CA′ and the signal CAX′. In the mixer 134, the weight given to the differential pair of the signal CB and the signal CBX in the mixer 130 is given to the signal CA′ and the signal CAX′.

As described above, the mixer 134 shifts the phases of the output signal CO′ and the output signal COX′ by weighting. The mixer 130 performs phase interpolation by shifting the phases of the output signal CO′ and the output signal COX′. In the second embodiment, the mixer 134 has a variable range of phase 90°. That is, a phase interpolation apparatus according to the second embodiment has a variable range of phase 180° due to the mixer 130 and the mixer 134.

The mixer 134 outputs the generated output signal CO′ from an output terminal 163. The mixer 134 outputs the generated output signal COX′ from an output terminal 164. The mixer 134 outputs the output signal CO′ and the output signal COX′ to the peak voltage detection unit 141. The mixer 134 is an example of a “second mixer”.

The peak voltage detection unit 140 receives an input of the output signal CO and the output signal COX from the mixer 130. The peak voltage detection unit 140 detects the output amplitude peak voltage of the output signal CO and the output signal COX. Then the peak voltage detection unit 140 outputs the detected output amplitude peak voltage to the comparator 150.

The peak voltage detection unit 141 receives an input of the output signal CO′ and the output signal COX′ from the mixer 134. The peak voltage detection unit 141 detects the output amplitude peak voltage of the output signal CO′ and the output signal COX′. Then the peak voltage detection unit 141 outputs the detected output amplitude peak voltage to the comparator 150. The peak voltage detection unit 141 is an example of a “second peak voltage detection unit”.

Hereinafter, the voltage detected by the peak voltage detection unit 140 is referred to as a first peak voltage, and the voltage detected by the peak voltage detection unit 141 is referred to as a second peak voltage.

The comparator 150 receives an input of the first peak voltage from the peak voltage detection unit 140. The comparator 150 receives an input of the second peak voltage from the peak voltage detection unit 141. Then the comparator 150 compares the first peak voltage with the second peak voltage.

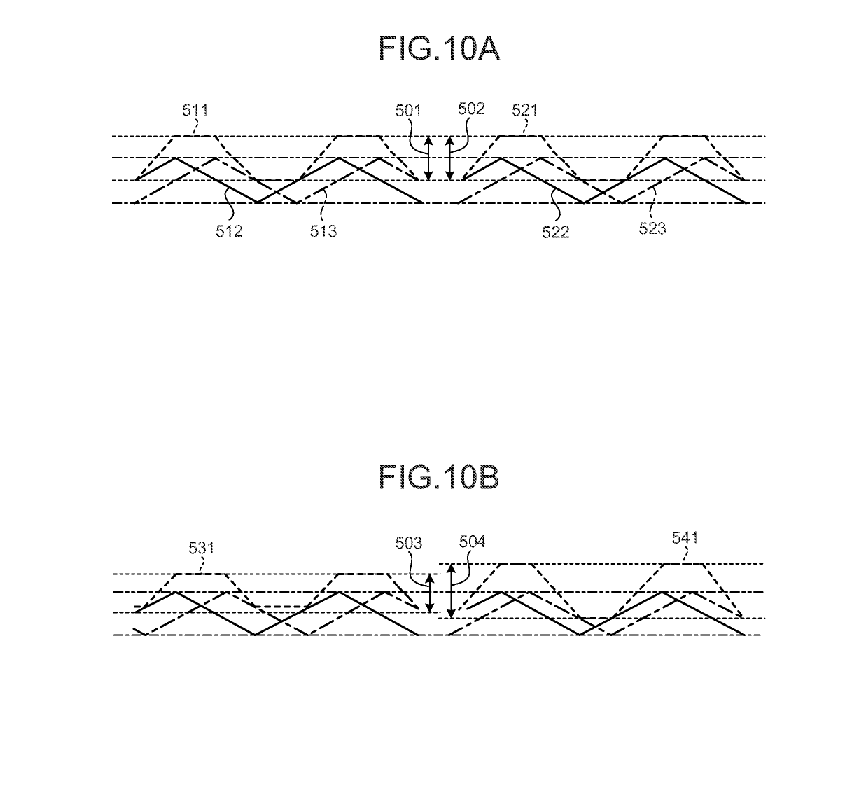

FIG. 10A illustrates the first peak voltage and the second peak voltage in a state where there is no skew shift. In FIG. 10A, a vertical axis represents an amplitude voltage and a horizontal axis represents a phase. A broken line 511 represents the differential wave form between the output signal CO and the output signal COX output from the mixer 130. A solid line 512 represents the differential wave form between the signal CA and the signal CAX input to the mixer 130. In addition, an alternate long and short dash line 513 represents the differential wave form between the signal CB and the signal CBX input to the mixer 130.

A broken line 521 represents the differential wave form between the output signal CO′ and the output signal COX′ output from the mixer 134. A solid line 522 represents the differential wave form between the signal CA′ and the signal CAX′ input to the mixer 134. In addition, an alternate long and short dash line 523 represents the differential wave form between the signal CB′ and the signal CBX′ input to the mixer 134.

When there is no skew shift, the first peak voltage is represented by a potential difference 501. When there is no skew shift, the second peak voltage is represented by a potential difference 502. As illustrated in FIG. 10A, the potential difference 501 is equal to the potential difference 502. That is, when there is no skew shift, the first peak voltage is equal to the second peak voltage.

In contrast, FIG. 10B illustrates the first peak voltage and the second peak voltage in a state where there is a skew shift. In FIG. 10B, a vertical axis represents an amplitude voltage and a horizontal axis represents a phase. A broken line 531 represents the differential wave form between the output signal CO and the output signal COX output from the mixer 130. A broken line 541 represents the differential wave form between the output signal CO′ and the output signal COX′ output from the mixer 134. As illustrated in FIG. 10B, when there is a skew shift, any one of the first peak voltage and the second peak voltage is lower than the output amplitude peak voltage in a case where there is no skew shift. The other one of the first peak voltage and the second peak voltage is higher than the output amplitude peak voltage in a case where there is no skew shift. For example, in FIG. 10B, the first peak voltage is represented by a potential difference 503 and the second peak voltage is represented by a potential difference 504. The potential difference 503 is lower than the potential difference 501 and the potential difference 502. The potential difference 504 is higher than the potential difference 501 and the potential difference 502. When the skew of the phases of the input signals is inverted, the relation between the first peak voltage and the second peak voltage is also inverted.

The state where the first peak voltage is equal to the second peak voltage is a case where there is no skew shift. The comparator 150 outputs the control signal to the variable delay circuit 111, 112, 115, and 116 to match the first peak voltage and the second peak voltage.

Specifically, when the first peak voltage is high, the comparator 150 outputs a control signal for increasing the delay given to the signal CA and the signal CAX and decreasing the delay given to the signal CB and the signal CBX to the variable delay circuit 111, 112, 115, and 116. When the second peak voltage is high, the comparator 150 outputs a control signal for decreasing the delay given to the signal CA and the signal CAX and increasing the delay given to the signal CB and the signal CBX to the variable delay circuit 111, 112, 115, and 116.

As described above, the phase correction circuit according to the second embodiment compares the output amplitude peak voltages of the outputs from the two mixers and controls the voltages to be the same. This corrects a skew shift between input differential pairs, and improves the accuracy of intervals of the phases of an input phase signal and the accuracy of the variable amount of an identification phase. The design thereof may be facilitated because an input of the reference voltage from outside is not used. When the phase correction circuit according to the second embodiment has a variable range of phase 180°, an increase in size thereof may be reduced because another mechanism for acquiring the reference voltage need not be provided.

### [c] Third Embodiment

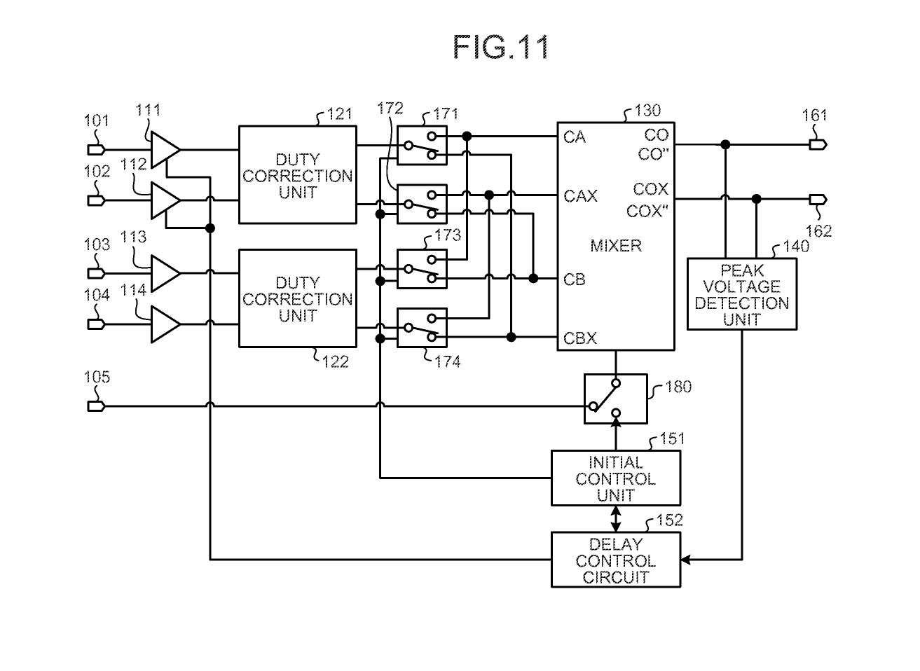

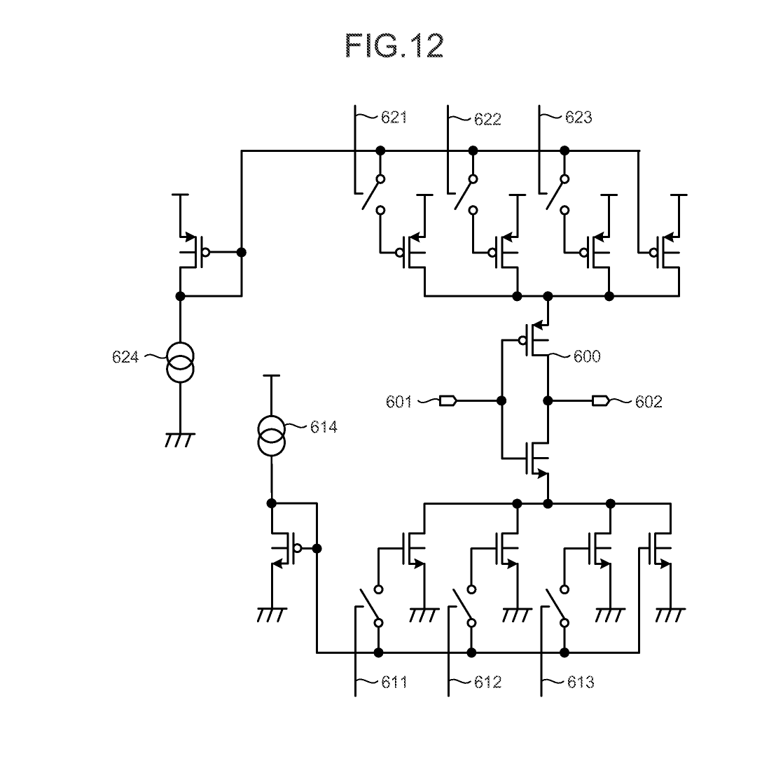

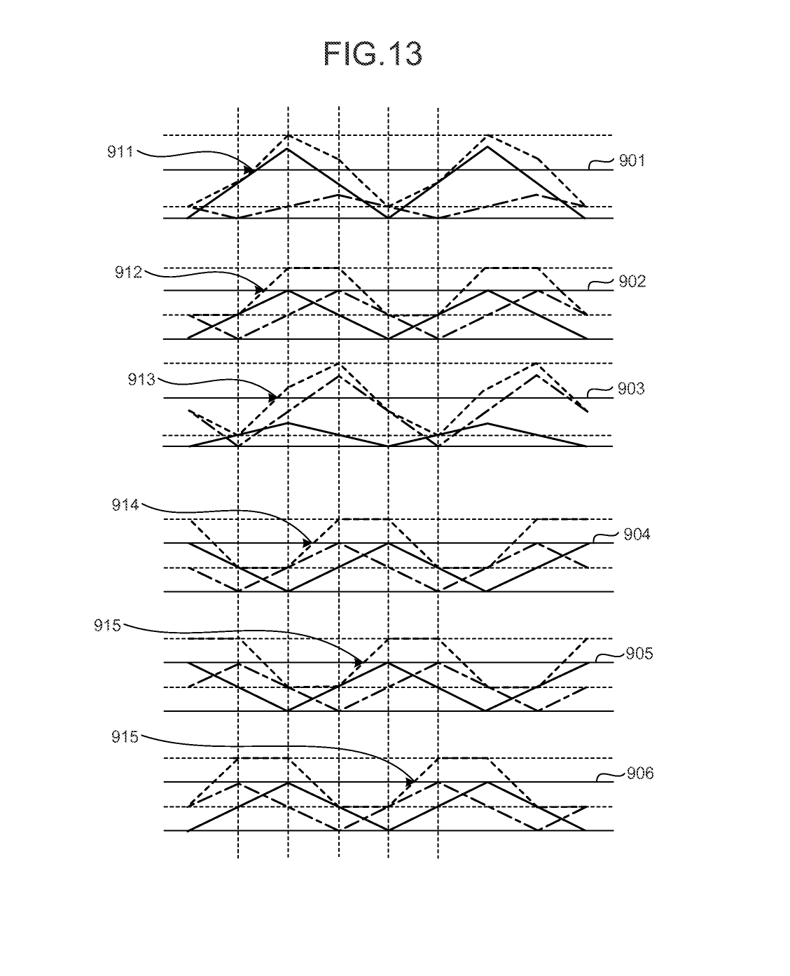

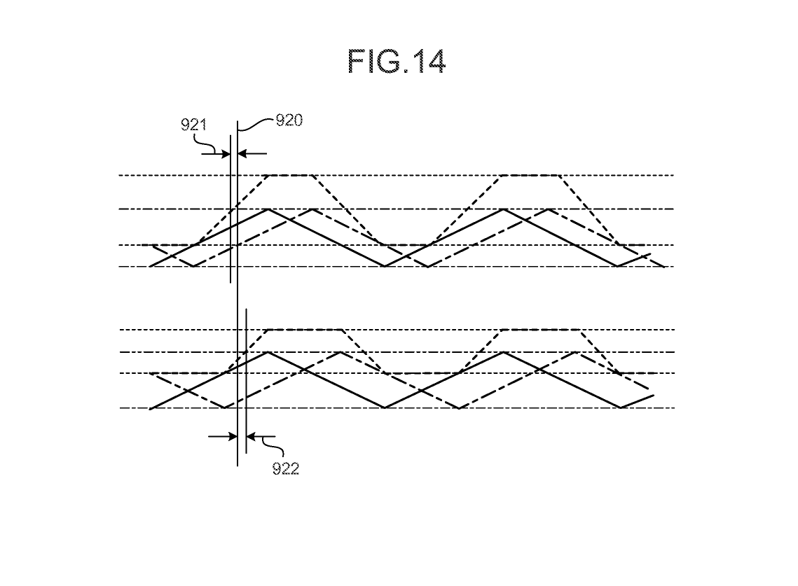

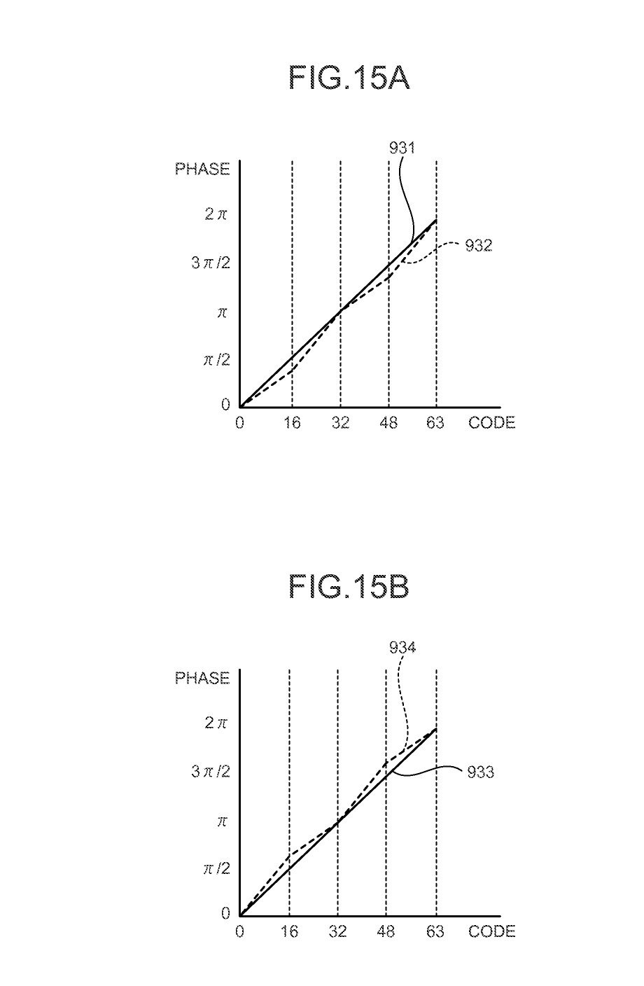

FIG. 11 is a block diagram of the phase correction circuit according to a third embodiment. The phase correction circuit according to the third embodiment is different from that in the first embodiment in that it generates a signal for comparing the output amplitude peak voltages by switching signals to be input to the mixer. Hereinafter, the generation of the signal for comparison and the control of the delay amount will be mainly described. In FIG. 11, each component having the same reference numeral as that in FIG. 1 has the same function as that in FIG. 1 unless specifically described.

The phase correction circuit according to the third embodiment includes an initial control unit 151, a delay control circuit 152, switches 171 to 174, and a selector 180 in addition to the first embodiment.

The switch 171 switches the path of a clock signal having a phase of 0° output from the duty correction unit 121 to a path for inputting as the signal CA or a path for inputting as the signal CBX to the mixer 130.

The switch 172 switches the path of a clock signal having a phase of 90° output from the duty correction unit 121 to a path for inputting as the signal CAX or a path for inputting as the signal CB to the mixer 130.

The switch 173 switches the path of a clock signal having a phase of 90° output from the duty correction unit 122 to a path for inputting as the signal CA or a path for inputting as the signal CB to the mixer 130.

The switch 174 switches the path of a clock signal having a phase of 270° output from the duty correction unit 121 to a path for inputting as the signal CAX or a path for inputting as the signal CBX to the mixer 130.

The selector 180 switches a path for inputting a signal from the initial control unit 151 to the mixer 130 and a path for inputting a signal from the input terminal 105 to the mixer 130.

When power supply is turned on and the initial training is started, the initial control unit 151 switches the selector 180 to a path connecting the initial control unit 151 and the mixer 130. Then the initial control unit 151 instructs the mixer 130 to match current that weights the signal CA and the signal CAX and current that weights the signal CB and the signal CBX.

In addition, the initial control unit 151 operates the switches 171 to 174 so that a clock signal to be actually used as an output is output. In the third embodiment, the initial control unit 151 switches the switch 171 to a path through which the clock signal having a phase of 0° is input as the signal CA to the mixer 130. The initial control unit 151 switches the switch 172 to a path through which the clock signal having a phase of 180° is input as the signal CAX to the mixer 130. The initial control unit 151 switches the switch 173 to a path through which the clock signal having a phase of 90° is input as the signal CB to the mixer 130. The initial control unit 151 switches the switch 173 to a path through which the clock signal having a phase of 270° is input as the signal CBX to the mixer 130. Hereinafter, this state of the switches 171 to 174 is referred to as a first switch state.

The initial control unit 151 receives an acquisition completion notification of the output amplitude peak voltage of a signal actually output from the delay control circuit 152 to be described later. Then the initial control unit 151 operates the switches 171 to 174 so that a signal for comparison is output. In the third embodiment, the initial control unit 151 switches the switch 171 to a path through which the clock signal having a phase of 0° is input as the signal CBX to the mixer 130. The initial control unit 151 switches the switch 172 to a path through which the clock signal having a phase of 180° is input as the signal CB to the mixer 130. The initial control unit 151 switches the switch 173 to a path through which the clock signal having a phase of 90° is input as the signal CA to the mixer 130. The initial control unit 151 switches the switch 173 to a path through which the clock signal having a phase of 270° is input as the signal CAX to the mixer 130. Hereinafter, this state of the switches 171 to 174 is referred to as a second switch state.

When the adjustment of the delay is completed, the initial control unit 151 receives a completion notification of adjustment of the delay from the delay control circuit 152. The initial control unit 151 switches the switches 171 to 174 to the first switch state so that the clock signal actually used as an output is output. Then the initial control unit 151 switches the selector 180 to a path through which a signal is input to the mixer 130 from the input terminal 105. The initial control unit 151 is an example of a “switching unit”.

In the first switch state, the mixer 130 generates the signal CO and the signal COX each of which is a synthesized signal from the signal CA having a phase of 0°, the signal CAX having a phase of 180°, the signal CB having a phase of 90°, and a signal CBX having a phase of 270°. Then the mixer 130 outputs the signal CO and the signal COX to the peak voltage detection unit 140.

In the second switch state, the mixer 130 generates a signal CO″ and a signal COX″ each of which is a synthesized signal from the signal CA having a phase of 90°, the signal CAX having a phase of 270°, the signal CBX having a phase of 0°, and the signal CB having a phase of 180°. Then the mixer 130 outputs the signal CO″ and the signal COX″ to the peak voltage detection unit 140.

In the first switch state, the peak voltage detection unit 140 receives inputs of the signal CO and the signal COX from the mixer 130. Then the peak voltage detection unit 140 detects the output amplitude peak voltage of the signal CO and the signal COX. Hereinafter, the output amplitude peak voltage is referred to as a “used output peak voltage”. The peak voltage detection unit 140 outputs the used output peak voltage to the delay control circuit 152.

In the second switch state, the peak voltage detection unit 140 receives inputs of the signal CO″ and the signal COX″ from the mixer 130. Then the peak voltage detection unit 140 detects the output amplitude peak voltage of the signal CO″ and the signal COX″. Hereinafter, the output amplitude peak voltage is referred to as a “comparison peak voltage”. The peak voltage detection unit 140 outputs the comparison peak voltage to the delay control circuit 152.

The delay control circuit 152 includes a storage device such as a memory. The delay control circuit 152 also includes an analog to digital (A/D) converter. The delay control circuit 152 receives a notification of starting the initial training from the initial control unit 151. The delay control circuit 152 receives an input of the used output peak voltage from the peak voltage detection unit 140. Then the delay control circuit 152 converts the used output peak voltage to a digital signal to be stored in the storage device of itself. After storing the used output peak voltage, the delay control circuit 152 notifies the initial control unit 151 that the used output peak voltage is acquired.

Next, the delay control circuit 152 receives an input of the comparison peak voltage from the peak voltage detection unit 140. The delay control circuit 152 converts the comparison peak voltage to a digital signal. The delay control circuit 152 compares the used output peak voltage that is stored with the received comparison peak voltage. Then the delay control circuit 152 controls the variable delay circuit 111 and the variable delay circuit 112 to match the used output peak voltage and the comparison peak voltage. For example, the delay control circuit 152 stores therein a voltage difference and a code for adjusting the voltage difference in association with each other. The delay control circuit 152 compares the detected voltage with the reference voltage to acquire the voltage difference. The delay control circuit 152 selects a code corresponding to the acquired voltage difference. The delay control circuit 152 transmits the selected code to the variable delay circuit 111 and the variable delay circuit 112. Then the delay control circuit 152 stores therein a delay amount set to the variable delay circuit 111 and the variable delay circuit 112 and fixes the delay amount in the variable delay circuit 111 and the variable delay circuit 112.

FIG. 12 illustrates an example of the variable delay circuit according to the third embodiment. In the third embodiment, the variable delay circuit 111 and the variable delay circuit 112 are digitally controlled, so that a variable delay circuit to be digitally controlled as illustrated in FIG. 12 is used as the variable delay circuit 111 and the variable delay circuit 112.

An inverter 600 outputs a clock signal from a terminal 602 using a clock signal input from a terminal 601. A constant current source 614 is a circuit for providing a constant current to the inverter 600 from lines 611 to 613 side. A constant current source 624 is a circuit for providing a constant current to the inverter 600 from lines 621 to 623 side.

A control signal from the delay control circuit 152 is input from the lines 611 to 613, and a designated switch is turned on. An inverted signal of the control signal from the delay control circuit 152, that is, a signal of which switching on and off is inverted is input from the lines 621 to 623, and the designated switch is turned on.

By adjusting the turning on and off of the switches, the number of the current sources of the inverter 600 is changed and current quantity to be input to the inverter varies. Accordingly, a driving capability of the inverter 600 can be changed, so that the charging and discharging time of a clock signal line is changed by controlling the driving capability of the inverter 600, and the delay amount can be correspondingly changed.

In the first embodiment and the second embodiment as well, the variable delay circuit illustrated in FIG. 12 may be used to digitally control the variable delay circuit 111 and the variable delay circuit 112.

As described above, the phase correction circuit according to the third embodiment generates a signal to be actually used and a signal for comparison with one mixer. Accordingly, the size of the phase correction circuit is further reduced.

According to an aspect of a phase correction circuit and a phase correction method disclosed herein, accuracy of the phase interval of the input phase signal is improved and accuracy of the variable amount of an identification phase is improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A phase correction circuit comprising:
a first delay addition unit that receives a first signal having a predetermined phase and outputs a first delay signal obtained by variably adding a delay value to the first signal;
a first mixer that receives the first delay signal and a second signal having a phase different from the predetermined phase, and outputs a synthesized signal of the first delay signal and the second signal;
a first peak voltage detection unit that detects a maximum value of an amplitude voltage of the synthesized signal output from the first mixer; and
a control unit that controls the delay value added by the first delay addition unit to match the maximum value detected by the first peak voltage detection unit and a predetermined voltage.

2. The phase correction circuit according to claim 1, wherein
the first signal is a first differential signal having a first normal rotation signal and a first inverted signal that is an inverted signal of the first normal rotation signal,
the second signal is a second differential signal having a second normal rotation signal having a phase different from that of the first normal rotation signal and a second inverted signal that is an inverted signal of the second normal rotation signal,
the first delay addition unit includes a first normal rotation signal delay addition unit that delays the first normal rotation signal and a first inverted signal delay addition unit that delays the first inverted signal upon receiving the first differential signal, and outputs a first delay differential signal that is a set of a signal obtained by delaying the first normal rotation signal and a signal obtained by delaying the first inverted signal as the first delay signal, and
the first mixer outputs a synthesized signal of a signal obtained by delaying the first normal rotation signal through the first normal rotation signal delay addition unit and the second normal rotation signal, and a synthesized signal of a signal obtained by delaying the first inverted signal through the first inverted signal delay addition unit and the second inverted signal.

3. The phase correction circuit according to claim 1, wherein the control unit stores therein control information of control to match the maximum value detected by the first peak voltage detection unit to a predetermined voltage when the maximum value detected by the first peak voltage detection unit is controlled to match a predetermined voltage, and controls a delay value added by the first delay addition unit based on the stored control information.

4. The phase correction circuit according to claim 2, further comprising:
a second delay addition unit that is provided at a front stage of the first mixer, includes a second normal rotation signal delay addition unit that delays the second normal rotation signal and a second inverted signal delay addition unit that delays the second inverted signal upon receiving the second differential signal, and outputs a second delay differential signal that is a set of a signal obtained by delaying the second normal rotation signal and a signal obtained by delaying the second inverted signal;
a second mixer that receives a third delay differential signal obtained by inverting normal rotation and inverted rotation of one of the first delay differential signal to which a delay is added by the first delay addition unit and the second delay differential signal to which a delay is added by the second delay addition unit, and the other delay differential signal, and outputs a synthesized signal of a normal rotation signal of the third delay differential signal and a normal rotation signal of the other delay differential signal and a synthesized signal of an inverted signal of the third delay differential signal and an inverted signal of the other delay differential signal; and
a second peak voltage detection unit that detects a maximum value of an amplitude voltage of the synthesized signal output from the second mixer, wherein
the control unit controls the delay value added by the first delay addition unit and the delay value added by the second delay addition unit to match the maximum value detected by the first peak voltage detection unit and the maximum value detected by the second peak voltage detection unit.

5. The phase correction circuit according to claim 2, wherein
the first mixer comprises a first receiving unit and a second receiving unit, and
the phase correction circuit further comprises a switching unit that switches a state where the first signal is input to the first receiving unit and the second signal is input to the second receiving unit to a state where the first signal obtained by replacing the first normal rotation signal with the first inverted signal is input to the second receiving unit and the second signal is input to the first receiving unit,
the first mixer gives a signal input to the first receiving unit a first weight indicating a ratio of the signal used for generating a synthesized signal and gives a signal input to the second receiving unit the first weight, and synthesizes the weighted signals to generate the synthesized signal,
the first peak voltage detection unit detects a maximum value of an amplitude voltage of a first synthesized signal that is a synthesized signal in a case where the first signal is input to the first receiving unit and the second signal is input to the second receiving unit, and further detects a maximum value of an amplitude voltage of a second synthesized signal that is a synthesized signal in a case where the first signal obtained by replacing the first normal rotation signal with the first inverted signal is input to the second receiving unit and the second signal is input to the first receiving unit, and
the control unit controls the first delay addition unit to match the maximum value of the amplitude voltage of the first synthesized signal and the maximum value of the second synthesized signal.

6. A phase correction method for controlling a phase correction circuit, the phase correction method comprising:
receiving a first signal having a predetermined phase;
generating a first delay signal obtained by adding a delay value to the first signal;
receiving a second signal having a phase different from the predetermined phase;
outputting a synthesized signal of the first delay signal and the second signal;
detecting a maximum value of an amplitude voltage of the synthesized signal; and
adding a delay value to the first signal to match the maximum value of the amplitude voltage of the synthesized signal and a predetermined voltage.
